(19) United States
(12) Patent Application Publication
(10) Pub. No.: US 2016/0103754 A1
(43) Pub. Date: Apr. 14, 2016

(54) METHOD AND SYSTEM FOR GRADING A COMPUTER PROGRAM

(71) Applicant: ASPIRING MINDS ASSESSMENT PRIVATE LIMITED, New Delhi (IN)

(72) Inventors: Varun AGGARWAL, New Delhi (IN); Shashank SRIKANT, Bangalore (IN)

(21) Appl. No.: 14/423,439

(22) PCT Filed: Jun. 23, 2014
(86) PCT No.: PCT/IB2014/062529

§ 371 Date: Aug. 12, 2015

(30) Foreign Application Priority Data
Jun. 24, 2013 (IN) 1853/DEL/2013

(51) Int. Cl. G06F 11/36

(52) U.S. Cl. CPC G06F 11/3608

(57) ABSTRACT

The system includes a receiving module configured to receive a first set of data and a second set of data, wherein the first set of data comprises one or more high quality objects, and one or more ungraded objects, wherein the second set of data comprises one or more ungraded objects, an identification module configured to identify the one or more high quality objects, an extraction module is configured to extract one or more features from each high quality object of the one or more high quality objects, a building module is configured to build a predictive model based on the one or more features extracted for the each high quality object, a comparison module configured to compares the one or more ungraded objects and the one or more high quality objects, and an assessment module configured to score the one or more ungraded objects.

### FIELD OF THE INVENTION

This is a national stage application of PCT/IB2014/062481 that takes priority from Indian Patent Application 1853/DEL/2013.

The present invention relates to automatic grading of computer programs. In particular, it relates to grading programs on the basis of automatically identified high quality programs and looking for similarity of the code, to be graded, to the automatically identified high quality set.

### BACKGROUND

Solving programming problems is one of the important aspects of learning computer-programming languages. But, the assessment of the solution to the programming problem is not straightforward. It is time consuming and involves several tedious steps to compile and test the solution.

Assessment of programming solutions gains importance when the software programs are used to assess a programmer for programming skills. Existing approaches assess proficiency manually by human assessors. In addition, the existing approaches also include a high operation cost, especially when large numbers of individuals are being assessed on an ongoing basis. However, there also exists a high cost for not performing proficiency assessments. Neglecting such assessments can lead to improper matching of skills to project requirements.

Presently there are several assessment tests such as Microsoft Certification, Java Certification and the like. However, these assessment tests only provide multiple-choice questions for the programmer to answer. The programmer does not perform the actual programming in the tests. As the result, a programmer without good programming skill can often achieve good grades by more rehearsals. On the other hand, a good programmer can get lesser grades due to the lack of exposure to the type of questions being asked in the test. This deficiency greatly reduces the credibility of the test results, and cannot provide a consistent and accurate measure of the genuine programming proficiency of the programmer. A good test for programming skill must have the programmer do the actual programming during the test. Hence, there is a requirement for a system for automatic assessment of programs.

The approach currently used for automatic assessment of programs is by evaluating the number of test cases they pass. However, programs that pass a high number of test cases may not be efficient and may have been written with bad programming practices. On the other hand, programs that pass a low number of test cases are many a-times quite close to the correct solution. Some unforced or inadvertent errors make them eventually fail the suite of test cases designed for the problem.

Another approach to the automated grading of programs makes use of measuring the similarity between abstract representations of a candidate's program and representations of correct implementations for the problem. However, the existence of multiple abstract representations for a correct solution to a given problem poses a problem to the implementation of this approach. In addition, there is an absence of an underlying rubric that guides the similarity metric and an absence of approaches to map the metric to the rubric discussed.

One common disadvantage associated with the prior art methods is that the parameters and features chosen for grading the software are not standardized and often involve lot of manual effort leading to increased cost. Further, the prior art methods need a lot of human annotated data to build an automatic grading system.

In light of the above discussion, there is a need for a method and a system to automate the process of software grading even when human annotated data is unavailable.

### SUMMARY

The above-mentioned shortcomings, disadvantages and problems are addressed herein which will be understood by reading and understanding the following specification. In various embodiments, the present invention provides a method for grading a computer program. The method includes obtaining a first set of data, wherein the first set of data comprises one or more objects and wherein the one or more objects comprises one or more graded objects or one or more high quality objects, and one or more ungraded objects, identifying the one or more high quality objects from the first set of data, wherein the one or more high quality objects are automatically identified based on certain parameters, extracting one or more features for each high quality object of the one or more high quality objects, wherein the one or more features comprises a control-flow information, a data-flow information, a data-dependency information, a control-dependency information and wherein the one or more features are expressed in quantitative values, building a predictive model, wherein building the predictive model is based on the one or more features extracted for each high quality object, obtaining a second set of data, wherein the second set of data comprises one or more ungraded objects, and comparing the one or more ungraded objects and the one or more high quality objects, wherein the comparison is based on certain techniques.

In another aspect, the present invention provides a system for grading the computer program. The system includes a receiving module configured to receive a first set of data and a second set of data, wherein the first set of data comprises one or more objects and wherein the one or more objects comprises one or more graded objects or one or more high quality objects, and one or more ungraded objects, wherein the second set of data comprises one or more ungraded objects, an identification module configured to identify the one or more high quality objects, an extraction module is configured to extract one or more features from each high quality object of the one or more high quality objects, a building module is configured to build a predictive model based on the one or more features extracted for the each high quality object, a comparison module configured to compare the one or more ungraded objects and the one or more high quality objects, and an assessment module configured to grade the one or more ungraded objects.

Systems and methods of varying scope are described herein. In addition to the aspects and advantages described in this summary, further aspects and advantages will become apparent by reference to the drawings and with reference to the detailed description that follows.

### BRIEF DESCRIPTION OF THE DRAWINGS

FIG. 1 illustrates a system for assessing one or more ungraded objects, in accordance with embodiments of the present invention;

FIG. 2 illustrates a block diagram of a grading engine, in accordance with embodiments of the present invention; and

FIG. 3 illustrates a flowchart for assessing one or more ungraded objects, in accordance with embodiments of the present invention.

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

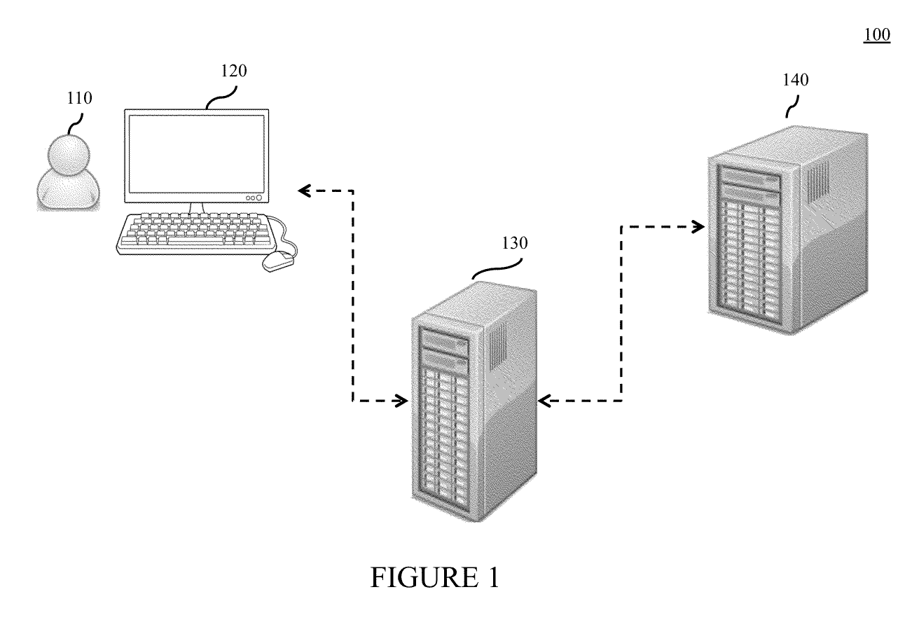

FIG. 1 illustrates a system 100 for assessing one or more ungraded objects, in accordance with embodiments of the present invention. The system 100 includes a programmer 110, an input computer 120, a grading engine 130 and a database 140.

The input computer 120 communicates with the programmer 110. The input computer 120 receives a first set of data from a system administrator and a second set of data from the programmer 110. The first set of data includes one or more objects. Further, the one or more objects include at least one of one or more graded objects or one or more high quality objects and one or more ungraded objects. The term used herein, the system administrator refers to a person with domain related knowledge. The system administrator retrieves the one or more high quality objects related to the programming problem from a database 140. The database 140 stores one or more graded objects/one or more high quality objects. The one or more graded objects/the one or more high quality objects are graded using a set of pre-determined parameters. The examples of the overall grade considered can be a monolithic grades pertaining to each grades, the consensus of two or more ratings and the like. The set of pre-determined parameters include, but may not be limited to an online portal, a crowd-sourced through an online platform, blogs related to programming, hand-graded assignments from computer courses in training institutions, through instructor assessed assignments from class, through contests devised for this purpose and the like.

In various embodiments, the one or more objects described herein, refer to, but may not be limited to a computer program. The one or more objects may also refer to a set of instructions being given to a machine, a command written in any programming language, and the like. Embodiments are now explained with respect to a computer program. In an embodiment, the programmer 110 is a professional writing a program in a programming language. In an example, the programmer 110 is a candidate taking up an online test. The online test includes a test for programming skills. In another example, the programmer 110 is an individual or community looking to learn computer programming. In yet another example, the programmer 110 is an individual or community in a Massive Open Online Course (MOOC). In yet another example, the programmer 110 is an individual or community participating in a Competitive Programming Contest.

In an embodiment, the one or more objects are written by the programmer 110 using a programming language. The programming language follows a programming paradigm. The examples of the programming paradigm include, but may not be limited to imperative programming, functional programming, procedural programming, event-driven programming, object-oriented programming, automata-based programming, declarative programming, and the like. The examples of the programming language include but, may not be limited to C, C++, python, Java™, pseudo-language, assembly language, and graphics-based languages like Visual C™, Visual Basic™, Java™ Swing and the like.

The second set of data includes the one or more ungraded objects. In an embodiment, the second set of data is a computer program written by the programmer 110. The second set of data is compatible at any stage of compilation process. The stage of compilation process includes, but may not be limited to, the one or more ungraded objects being written down via paper-pencil and may not be interpretable/compilable or executable, the one or more ungraded objects are checked for interpretation/compilation errors but may not be executable, the one or more ungraded objects are interpreted/compilable and executable but may have interpretation and compilation errors, the one or more ungraded objects are interpreted/compilable and executable, and free of interpretation and compilation errors but may have runtime errors and the like.

The input computer 120 communicates with the grading engine 130. The grading engine 130 automatically grades the inputs from the input computer 120. The purpose of the grading engine includes but, may not be limited to a system to mimic human evaluation. In an example, the grading engine 130 aids in providing a feedback to the writer of the program. In another example, the grading engine 130 aids in providing feedback to a company or interviewer looking to hire candidates. In yet another embodiment, the grading engine 130 aids in providing feedback to aid learning of an individual or community. In yet another embodiment, the grading engine 130 aids in providing feedback to an individual or community in a Massive Open Online Course (MOOC), providing feedback to an individual or community in a Competitive Programming Contest. Further, the grading engine 130 communicates with the database 140.

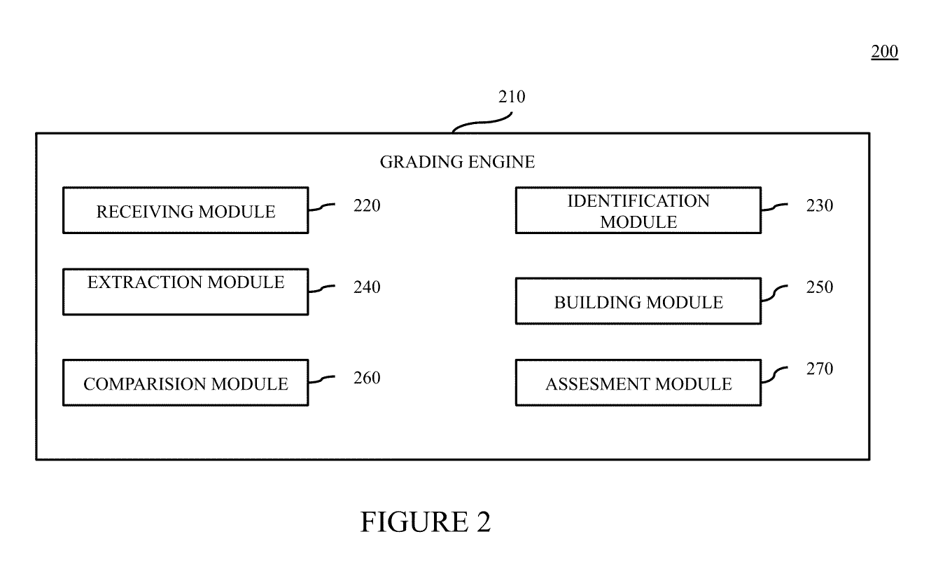

FIG. 2 illustrates a block diagram 200 of a grading engine 210, in accordance with various embodiments of the present invention. The functions and capabilities of the grading engine 210 are the same as the functions and capabilities of the grading engine 130. The grading engine 210 includes a receiving module 220, an identification module 230, an extraction module 240, a building module 250, a comparison module 260 and an assessment module 270.

The receiving module 220 receives the first set of data and the second set of data. The first set of data that includes the one or more high quality objects are provided by the system admin for a particular programming problem. The second set of data that includes the one or more ungraded objects that are provided by the programmer 110 via the input computer 120. The identification module 230 identifies the one or more high quality objects from the first set of data. In an embodiment, the high quality objects are computer programs that solve the required functionality. The identification module 230 identifies the one or more high quality objects automatically based on certain parameters. The certain parameters are a set of empirical properties of the one or more high quality objects. Examples of the set of empirical properties are, but may not be limited to a number of test cases passed by the one or more high quality objects, the one or more high quality objects algorithmic efficiency measured by its time complexity, a space complexity, coding best practices followed by the one or more high quality objects, coding best practices are determined by static, dynamic analysis of the source code of one or more high quality objects.

The extraction module 240 extracts one or more features from each high quality object of the one or more identified high quality objects. The one or more features are extracted from the abstract structures representing control information, data information and the like of the each high quality object. Examples of the abstract structures are, but may not be limited to control flow graphs, control dependence graphs, data-flow graphs, data dependence graphs, program dependence graphs, use-define chains and the like. The one or more features are extracted from the abstract structures of the each high quality object using a syntactic analysis technique. Examples of the syntactic analysis technique are, but may not be limited to parsing, using regular expression, using lexical analysis and the like.

In an embodiment, the method to extract the one or more features from the each high quality object is by counting the occurrences of one or more keywords and tokens appearing in the source code of the each high quality object. In an embodiment, the extraction of the one or more features is by counting the number of variables declared, counting the occurrences of keywords used in each high quality object such as ‘for’, ‘while’, ‘break’ and the like. In yet another embodiment, the extraction of the one or more features is by counting the occurrences of operators defined by a language such as ‘+’, ‘−’, ‘*’, ‘%’ and the like. In yet another embodiment, the extraction of the one or more features is by counting the number of character constants used in the program such as ‘0’, ‘1’, ‘2’, ‘100’ and the like. In yet another embodiment, the extraction of the one or more features is by counting the number of external function calls such as print( ) count( ) counting the number of unique data-types instantiated such as ‘integer’, ‘float’, ‘char’, ‘pointer to an integer’ and the like. In an embodiment the counting is made specific to the operators used, external functions called, constants used, data types used, such as counting the occurrences of ‘+’, ‘−’, ‘print’, ‘100’ and the like. In another embodiment, the counting is made generic to counting just the total number of unique operators appearing, total number of external function calls made, and the like.

In another embodiment, the method to extract the one or more features from the each high quality object is by counting the occurrences of expressions containing various keywords and token. An expression in a programming language. The programming language is a combination of explicit values, constants, variables, operators, and functions that are interpreted according to the particular rules of precedence and of association for a particular programming language, which computes and then produces another value. The method includes, but is not limited to, counting the number of expressions that contain one or more operators and one or more variables. In an embodiment, the count is made specific to the operators used, external functions called, constants used, variables used, the data-types of the variables used and the like in the expression. In an embodiment, the count is made generic to counting the total number of unique operators appearing, total number of external function calls and the like, in the expression. Abstract program structures that are used to extract these features can include but are not limited to abstract syntax trees and the like.

In yet another embodiment, the method to extract the one or more features from the each high quality object is by extracting data-dependency features. The data-dependency features include, but may not be limited to, counting the occurrence of any particular kind of expression that is dependent on another expression. Such features include counting the occurrence of a set of dependent expressions wherein each expression may be dependent on any other expression in the set. This feature captures a plurality of dependencies of a particular expression on any another expression either in the same count or may count it in different counts.

In yet another embodiment, the method to extract the one or more features from the each high quality object is by counting the occurrences one or more expressions, keywords, tokens and the like, in context of the control-flow structure in which they appear. Such features include, but are not limited to, counting the number of times a particular expression, keyword, token and the like that appear within a hierarchical configuration that appears in the computer program. In an embodiment, the count is specific to the control-flow structures the features appear in, by maintaining separate counts for the occurrence of a loop. In another embodiment, the count is generic to counting the type of control-flow structure such as a loop.

In yet another embodiment, the method to extract the one or more features from the each high quality object is by counting the data dependencies and control dependencies of each variable instantiated in the each high quality object. In an embodiment, such features include, but are not limited to, counting use-define properties of a variable with the context of the control-flow structure in which it appears. In an embodiment, such features include, but are not limited to, counting use-define properties of a variable without the context of the control-flow structure in which it appears. The use-define properties of a variable includes counting the number of times a variable has been declared, number of times the variable is assigned, number of times the variable is assigned and the like. In an embodiment, the count is specific to the number of times it is assigned to a particular data-type, number of times it is assigned to a particular expression, number of times it is associated with a specific and with a generic operator and the like. The abstract program structures that are used to extract these features can include but are not limited to abstract syntax trees, use-define chains, control flow graphs, control dependence graphs, data-flow graphs, data dependence graphs, program dependence graphs and the like. Further, the extraction module 240 extracts the one or more features for each ungraded object of the second set of data. The one or more features extracted by the extraction module 240 determines the quality of the each ungraded object.

The building module 250 builds a predictive model using the one or more features extracted from the each high quality object of the one or more high quality objects. The predictive model infers the input computer program for functional errors, logical errors and the like. The one or more features required to build the predictive model are selected by at least one of a machine learning approach, an expert driven approach, a rule-based technique. The machine learning approach includes, but may not be limited to a linear regression, a generalized linear regression, a ridge regression, bagging, boosting, genetic programming, a forward selection, a backward selection, a decision tree, a random forest and the like. The expert driven approach involves a domain expert deciding which of the one or more features to use for a problem and how to use them. The selection of the one or more features in the expert driven approach includes, but may not be limited to selecting features which were extracted/observed from/in the one or more identified high quality objects, pre-assigning different weights to those features extracted/observed from the one or more identified high quality objects and then using them, and the like. In an embodiment, the model is built on the whole data of set of programs graded using pre-determined parameters. In another embodiment, separate models are built for different grade ranges of the set of programs graded using pre-determined parameters.

In an embodiment, the one or more features extracted from the each high quality object are used to determine an efficiency of the second set of data. The second set of data includes one or more ungraded objects. The efficiency of each ungraded object is determined in accordance with various attributes. Examples of the attributes include, but may not be limited to, time taken to execute the set of instruction, memory space used by the each ungraded object and the like. In another embodiment, the one or more features extracted are used to detect bugs present in the set of instructions corresponding to the each ungraded object. In yet another embodiment, the one or more features extracted are used to correct the errors present in the set of instructions corresponding to the each ungraded object. In yet another embodiment, the features extracted are used to convert the set of instructions corresponding to the each ungraded object into another machine interpretable language.

The comparison module 260 compares the one or more ungraded objects with one or more high quality objects. The comparison module 260 compares based on certain techniques. The certain techniques determine whether the one or more features of the each ungraded object are same as the one or more features extracted for each identified high quality object of the one or more high quality objects. Examples of the certain techniques include, but may not be limited to one class classification, extreme value analysis method, density estimation method, a Local Outlier Factor (LOF) method, a Local Correlation Integral (LOCI) method, support vector method and the like.

The comparison module 260 compares the one or more ungraded objects with the one or more high quality objects considering both the one or more features of each ungraded object and the one or more features of the each high quality object.

The assessment module 270 evaluates the each ungraded program that belongs to the same class of the one or more high quality objects by using the predictive model. The evaluation of the each ungraded object is based on certain criteria. The certain criteria is for example similarity or the relationship of the each ungraded object with the one or more high quality objects. In an embodiment, evaluating the one or more ungraded objects is done by determining the similarity/relationship of the each ungraded object with the one or more identified high quality objects. The similarity is determined by calculating the distance between the each ungraded object with the one or more high quality objects in the same class. The distance is calculated using a metric space. Examples of the metric space include, but may not be limited to a Euclidean n-space, a normed vector space, variations of the shortest-path metric and the like. Examples of the distance that are calculated using the metric space include, but may not be limited to a Euclidean distance, a Manhattan distance, a Chebyshev distance, a Kolmogorov distance, a Levenshtein distance and the like.

Further, the assessment module 270 provides one or more grades to each evaluated ungraded object. The one or more grades include, but may not be limited to grades representing how many test cases have passed, the confidence of the predicted grades, run-time parameters such as number of successful compilations made, number of buffer overruns and the like. Additionally, the grades are provided in any range that would make comparison of two grades possible. This includes, but may not be limited to alphabetical grades, integer grades in the range 0-100, fractional grades in the range 0-1 and the like.

In an embodiment, the grading engine 210 detects missing instructions from each ungraded object. The missing instructions are identified by comparing the each ungraded object with the each high quality object. Further, the grading engine 210 fills in the missing instructions in the each ungraded object. In another embodiment, the grading engine 210 detects duplication in the set of instructions in the each ungraded object. In yet another embodiment, the grading engine 210 generates an application-programming interface for the each ungraded object.

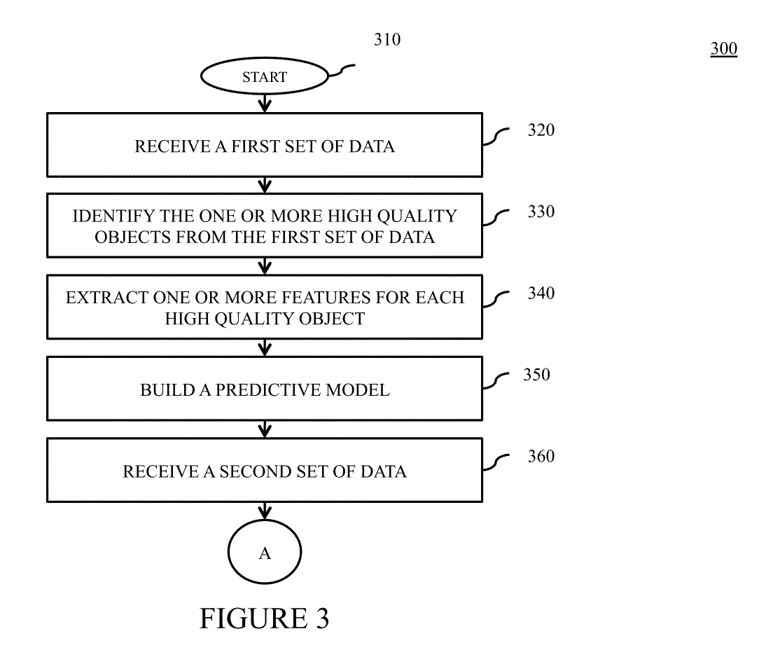

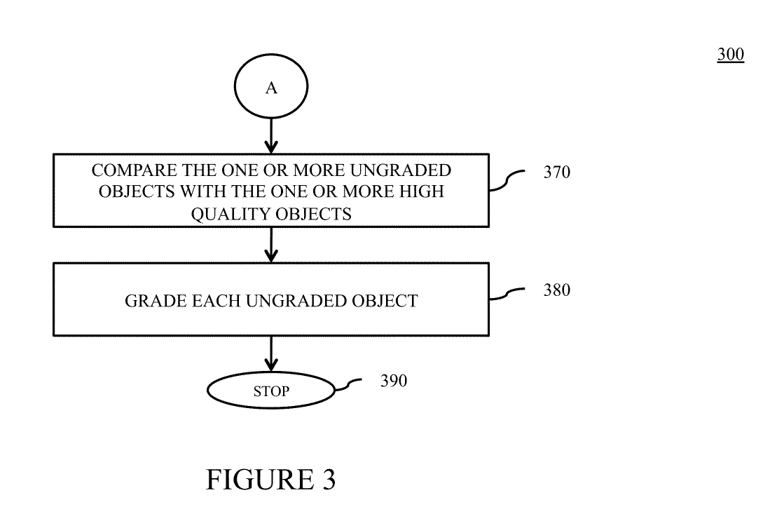

FIG. 3 illustrates a flowchart 300 for assessing one or more ungraded objects, in accordance with various embodiments of the present invention. The flow initiates at step 310. At step 320, the grading engine 130 receives the first set of data. The first set of data includes the one or more graded objects or the one or more high quality objects and the one or more ungraded objects. At step 330, the grading engine 130 identifies the one or more high quality objects from the first set of data.

At step 340, the grading engine 130 extracts the one or more features of the each high quality object of the one or more high quality objects. At step 350, the grading engine 130 builds the predictive model using the one or more features extracted from each high quality object. At step 360, the grading engine 130 receives the second set of data. The second set of data includes the one or more ungraded objects. Further, the grading engine 130 extracts one or features for each ungraded object of the second set of data. At step 370, the grading engine 130 compares the one or more features of the each ungraded object with the one or more features of the one or more high quality objects. The comparison is based on certain techniques. The grading engine 130 compares the one or more ungraded objects with the one or more high quality objects considering both the one or more features extracted for each ungraded object and the one or more features extracted for each high quality object. At step 380, the grading engine grades the each ungraded object based on the comparison done at step 370. At step 390, the flowchart 300 terminates.

This written description uses examples to describe the subject matter herein, including the best mode, and to enable any person skilled in the art to make and use the subject matter. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for grading a computer program, the method comprising:
a. obtaining a first set of data, wherein the first set of data comprises one or more objects and wherein the one or more objects comprises one or more graded objects or one or more high quality objects, and one or more ungraded objects;
b. identifying the one or more high quality objects from the first set of data, wherein the one or more high quality objects are automatically identified based on certain parameters;
c. extracting one or more features for each high quality object of the one or more high quality objects;
d. building a predictive model, wherein building the predictive model is based on the one or more features extracted for each high quality object;
e. obtaining a second set of data, wherein the second set of data comprises one or more ungraded objects;
f. comparing the one or more ungraded objects with the one or more high quality objects, wherein the comparison is based on certain techniques; and
g. grading each ungraded object, wherein the grading is based on the comparison of one or more ungraded objects with the one or more high quality objects.

2. The method as claimed in claim 1, comprising extracting one or more features for each ungraded object of the second set of data;

3. The method as claimed in claim 2, wherein the one or more features extracted for each ungraded object determine the quality of each ungraded object.

4. The method as claimed in claim 1, wherein the one or more features comprises a control-flow information, a data-flow information, a data-dependency information, a control-dependency information and wherein the one or more features are expressed in quantitative values.

5. The method as claimed in claim 1, wherein the certain parameters to identify the one or more high quality objects comprises at least one of a number of test cases passed, an algorithmic efficiency, a space complexity, a coding best practice determined by static and dynamic analysis of the one or more high quality objects.

6. The method as claimed in claim 1, wherein the certain techniques comprises at least one of a one class classification, an extreme value analysis method, a probability density estimation method, a local outlier factor method, local correlation integral method, data description method, a support vector machine method.

7. The method as claimed in claim 1, wherein grading the one or more ungraded objects comprises at least one of alphabetical grades, integer grades, and fractional grades.

8. The method as claimed in claim 1, wherein the certain techniques is based on a distance of the each ungraded object from the identified one or more high quality objects.

9. The method as claimed in claim 6, wherein a metric space used to perform distance calculation comprises at least one of a Euclidean n-space, a normed vector space, variations of the shortest-path metric.

10. A system for grading a computer program, the system comprising:
a. a receiving module, wherein the receiving module is configured to receive a first set of data and a second set of data, wherein the first set of data comprises one or more objects and wherein the one or more objects comprises one or more graded objects or one or more high quality objects, and one or more ungraded objects, wherein the second set of data comprises one or more ungraded objects;
b. an identification module, wherein the identification module is configured to identify the one or more high quality objects;
c. an extraction module, wherein the extraction module is configured to extract one or more features from each high quality object of the one or more high quality objects;
d. a building module, wherein the building module is configured to build a predictive model based on the one or more features extracted for the each high quality object;
e. a comparison module, wherein the comparison module is configured to compare the one or more ungraded objects and the one or more high quality objects; and
f. an assessment module, wherein the assessment module is configured to grade the one or more ungraded objects.

11. The system as claimed in claim 10, wherein the extraction module further extracts one or features for each ungraded object of the second set of data.

12. The system as claimed in claim 10, wherein the comparison module compares the one or more ungraded objects with the one or more high quality objects based on certain techniques.

13. The system as claimed in claim 10, wherein the assessment module provides one or more grades for each ungraded object.

14. The system as claimed in claim 13, the assessment module provides one or more grades based on at least one of a number of test cases passed by the each ungraded object, confidence of a predicted score, a number of successful compilations made, a number of buffer overruns.
